(19) United States
(12) Patent Application Publication
(10) Pub. No.: US 2024/0329411 A1
(43) Pub. Date: Oct. 3, 2024

(54) RELEASE MECHANISM

(71) Applicant: Apple Inc., Cupertino, CA (US)

(72) Inventors: Paul X. WANG, Cupertino, CA (US); Jason C. SAUERS, Sunnyvale, CA (US)

(21) Appl. No.: 18/579,294

(22) PCT Filed: Jul. 12, 2022
(86) PCT No.: PCT/US2022/036860

§ 371 Date: Jan. 12, 2024

Related U.S. Application Data
(60) Provisional application No. 63/222,907, filed on Jul. 16, 2021.

(51) Int. Cl. G02B 27/01

(52) U.S. Cl. CPC G02B 27/0176

(57) ABSTRACT

Head-mountable devices can include connection and engagement mechanisms that facilitate operation of a head-mountable device with an accessory device. Such connections can provide both mechanical engagement and operable communication between the connected devices. A variable lock of the head-mountable device can distinguish between low-impulse and high-impulse forces applied to one or more connection regions. In the event of a low-impulse force, the variable lock can secure segments of a head engager together so the head-mountable device can remain on the head of the user. Optionally, the accessory device can be disconnected from the head-mountable device. In the event of a high-impulse force, the variable lock can allow segments of the head engager to separate so the head-mountable device can be released from the head of the user.

### CROSS-REFERENCE TO RELATED APPLICATION

This application claims the benefit of U.S. Provisional Application No. 63/222,907, entitled “HEAD-MOUNTABLE DEVICE WITH RELEASE MECHANISM,” filed Jul. 16, 2021, the entirety of which is hereby incorporated herein by reference.

### TECHNICAL FIELD

The present description relates generally to head-mountable devices, and, more particularly, to head-mountable devices with release mechanisms.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include audio output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a side view of a head-mountable device and an accessory device, in accordance with embodiments of the present disclosure.

FIG. 2 illustrates a top view of the head-mountable device and the accessory device of FIG. 1 with the accessory device remaining connected to the head-mountable device upon application of a first force, in accordance with embodiments of the present disclosure.

FIG. 3 illustrates a top view of the head-mountable device and the accessory device of FIG. 1 with the accessory device being disconnected upon application of a first force, in accordance with embodiments of the present disclosure.

FIG. 4 illustrates a top view of the head-mountable device and the accessory device of FIG. 1 with segments of the head engager of the head-mountable device being disconnected from each other upon application of a second force, in accordance with embodiments of the present disclosure.

FIG. 5 illustrates a variable lock comprising a clip, the variable lock engaging a tether upon application of a first force, in accordance with embodiments of the present disclosure.

FIG. 6 illustrates the variable lock of FIG. 5, the variable lock disengaging the tether upon application of a second force, in accordance with embodiments of the present disclosure.

FIG. 7 illustrates a variable lock comprising a ratchet device, the variable lock engaging a tether upon application of a first force, in accordance with embodiments of the present disclosure.

FIG. 8 illustrates the variable lock of FIG. 7, the variable lock disengaging the tether upon application of a second force, in accordance with embodiments of the present disclosure.

FIG. 9 illustrates a variable lock comprising a magnetic friction lock, the variable lock engaging a tether upon application of a first force, in accordance with embodiments of the present disclosure.

FIG. 10 illustrates the variable lock of FIG. 9, the variable lock disengaging the tether upon application of a second force, in accordance with embodiments of the present disclosure.

FIG. 11 illustrates a variable lock comprising at least one electromagnet, the variable lock connecting segments of a head engager upon application of a first force, in accordance with embodiments of the present disclosure.

FIG. 12 illustrates the variable lock of FIG. 11, the variable lock disconnecting the segments of the head engager upon application of a second force, in accordance with embodiments of the present disclosure.

FIG. 13 illustrates a block diagram of a head-mountable device and an accessory device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mounted displays, headsets, visors, smartglasses, head-up display, etc., can perform a range of functions that is determined by the components (e.g., sensors, circuitry, and other hardware) included with the wearable device as manufactured. However, space, cost, and other considerations may limit the ability to provide every component that might provide a desired function. For example, different users may have different preferences regarding the components and functions that are provided by a given head-mountable device. Some users may desire certain capabilities, such as high-resolution display and long battery life, while other users may desire other capabilities, such as smaller form factor. Furthermore, a given user may desire different functions at different times. For example, a given user may desire high-resolution display at home and long battery life when outside the home.

Given the diversity of desired components and functions, it would be beneficial to allow a user to select an accessory device for use with a head-mountable device to customize the user experience according to the user's desires. By providing an accessory device that is separate from but connectable to the head-mountable device, the head-mountable device may be subject to forces applied to the accessory device. For example, if the accessory device is dropped, pulled, or moved a certain distance away from the head-mountable device, a corresponding force may be applied to the head-mountable device. Depending on the type of force, it may be beneficial to either release the accessory device from the head-mountable device or release the head-mountable device from the user.

Head-mountable devices of the present disclosure can include connection and engagement mechanisms that facilitate operation of a head-mountable device with an accessory device. Such connections can provide both mechanical engagement and operable communication between the connected devices. A variable lock of the head-mountable device can distinguish between low-impulse and high-impulse forces applied to one or more connection regions. In the event of a low-impulse force, the variable lock can secure segments of a head engager together so the head-mountable device can remain on the head of the user. Optionally, the accessory device can be disconnected from the head-mountable device. In the event of a high-impulse force, the variable lock can allow segments of the head engager to separate so the head-mountable device can be released from the head of the user.

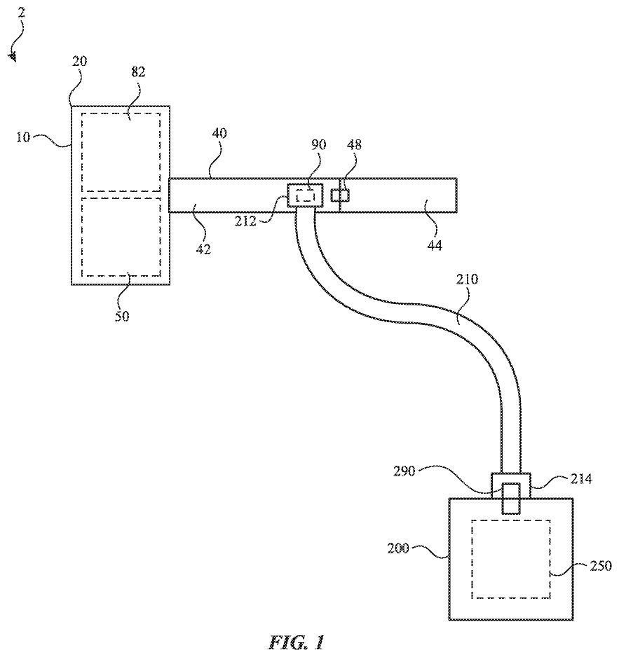

These and other embodiments are discussed below with reference to FIGS. 1-13. However, those skilled in the art will readily appreciate that the detailed description given herein with respect to these Figures is for explanatory purposes only and should not be construed as limiting.

According to some embodiments, for example as shown in FIG. 1, a system 2 can include a head-mountable device 10 the includes a frame 20 that is worn on a head with a head engager 40. The frame 20 can be positioned in front of the eyes of a user to provide information within a field of view of the user. The frame 20 can provide nose pads or another feature to rest on a user's nose. The frame 20 further includes one or more displays 50 (e.g., one for each eye) and a bridge above the nose pads and connecting multiple displays 50. The head-mountable device 10 can include a camera 58 for capturing a view of an environment external to the head-mountable device 10. The display 50 can provide visual (e.g., image or video) output based on the view captured by the camera 58. For example, a display 50 can transmit light from or based on a physical environment for viewing by the user. The display 50 can include components with optical properties, such lenses for vision correction based on incoming light from the physical environment. Additionally or alternatively, a display 50 can provide information as a display within a field of view of the user. Displayed information can be provided to the exclusion of a view of a physical environment or in addition to (e.g., overlaid with) a physical environment.

The frame 20 and/or the head engager 40 can serve to surround a peripheral region of the head-mountable device 10 as well as support any internal components in their assembled position. For example, the frame 20 and/or the head engager 40 can enclose and support various internal components (including for example integrated circuit chips, processors, sensors, input/output devices, memory devices, and other circuitry) to provide computing and functional operations for the head-mountable device 10, as discussed further herein.

The frame 20 can be supported on a user's head with the head engager 40. The head engager 40 can wrap or extend along opposing sides of a user's head. It will be appreciated that a variety of configurations can be applied for securing the head-mountable device 10 to a user's head. For example, one or more bands, straps, belts, caps, hats, or other components can be used in addition to or in place of the illustrated components of the head-mountable device 10.

A system 2 of the present disclosure provide a head-mountable device 10 with an attachable, removable, and/or exchangeable accessory device 200 that provide a variety of different components and functions to achieve the results that are desired by a user. As shown in FIG. 1, the accessory device 200 can be separate from but connectable to the head-mountable device 10. The head-mountable device 10 can include one or more tether connectors 90 for mechanically and operably (e.g., communicatively) connecting to the accessory device 200. For example, the head-mountable device 10 can include tether connectors 90 at the head engager 40 and/or the frame 20. The accessory device 200 can include a tether 210 with end portions 212 and 214. The end portion 212 can be configured to mechanically and operably (e.g., communicatively) connect to the head-mountable device 10 via the tether connector 90, and the end portion 214 can be configured to mechanically and operably (e.g., communicatively) connect to the body 230 of the accessory device 200.

The head-mountable device 10 can be provided with one or more accessory devices 200 for further enhancing functionality of the head-mountable device 10. For example, an accessory device 200 can be attached and operably connected, for example, to the head engager 40. While a single accessory device 200 is shown, it will be understood that the description herein can apply to any number of accessory device 200 simultaneously or alternately connected to the head-mountable device 10.

The accessory device 200 can include one or more accessory circuitry 250 that provide functions to the head-mountable device 10 when connected thereto, as described herein. The accessory device 200 can be coupled to the head-mountable device 10, such as the head engager 40 and/or the frame 20, by one or more tethers 210. For example, tether connectors 90 can be provided on an inner, outer, top, bottom, front, or rear side of the head engager 40 and/or the frame 20 to couple to the tether 210. By further example, the accessory device 200 can attach to the head-mountable device 10 with one or more tether connectors 90 and one or more body connectors 290. Attachment can be achieved with an engagement that holds end portions 212 and 214 of the accessory device 200 in place relative to the head-mountable device 10 and/or the body 230 of the accessory device 200 until release, as described further herein.

An electrical or other communication connection can be made and maintained upon mechanical securement of the tether connectors 90 and the body connectors 290, for example via an HMD communication interface and an accessory communication interface. When the head-mountable device 10 is connected to the accessory device 200, components of both can be in operative communication with each other. For example, components of the accessory device 200 can be in operative communication with components of the head-mountable device 10.

In some embodiments, the accessory device 200 can be a device that can be held or carried by a user. In some embodiments, the accessory device 200 can be a wearable device that is worn optionally near the head-mountable device 10. The accessory device 200 can be worn on a head, neck, ear, shoulders, and/or other portion of the user and/or the user's clothing (e.g., pocket). The accessory device 200 can include an engager to secure the accessory device 200 to or near a user.

As used herein, “accessory” can refer to a characteristic that allows an item, such as an accessory device, to be connected, installed, removed, swapped, and/or exchanged by a user in conjunction with a head-mountable device. It will be understood that the head-mountable device can be operable with or without use of the accessory device and that the accessory device can provide additional functionality to the head-mountable device when installed. Connection of an accessory device with a head-mountable device can be performed and reversed, followed by disconnection and connection of another accessory device with the same head-mountable device or another head-mountable device with the same accessory device. As such, multiple accessory devices can be exchangeable with each other with respect to a given head-mountable device. Further, multiple head-mountable devices can be exchangeable with each other with respect to a given accessory device.

An accessory device can be connected to a head-mountable device in a manner that allows the accessory device to be removed thereafter. The connection can be fully reversible, such that when the accessory device and the head-mountable device are disconnected, each is restored to a condition held prior to the connection. The connection can be fully repeatable, such that after the accessory device and the head-mountable device are disconnected, the same or a different head-mountable device and accessory device pair can be connected in the same way. The accessory device and head-mountable device can be securely and temporarily connected, rather than permanently, fixedly, or resiliently connected (e.g., via chemical and/or molecular bond). For example, connection and disconnection of the accessory device and head-mountable device are facilitated in a manner that does not cause permanent damage, harm, or deformation to the accessory device or the head-mountable device.

An accessory device can be connected to and disconnected from a head-mountable device with ease by a user. The connection and/or disconnection can be achieved repeatedly and reversibly by hand, rather than requiring a tool.

For example, a locking mechanism and/or a release mechanism can be provided on the accessory device and/or the head-mountable device for ready access by a user. A force required by a user to connect and/or disconnect the accessory device and the head-mountable device can be within a typical range for a user's fingers. For example, a force required to connect and/or disconnect the accessory device and the head-mountable device can be less than 1 N, 5 N, 10 N, 15 N, 20 N, 25 N, or 30 N.

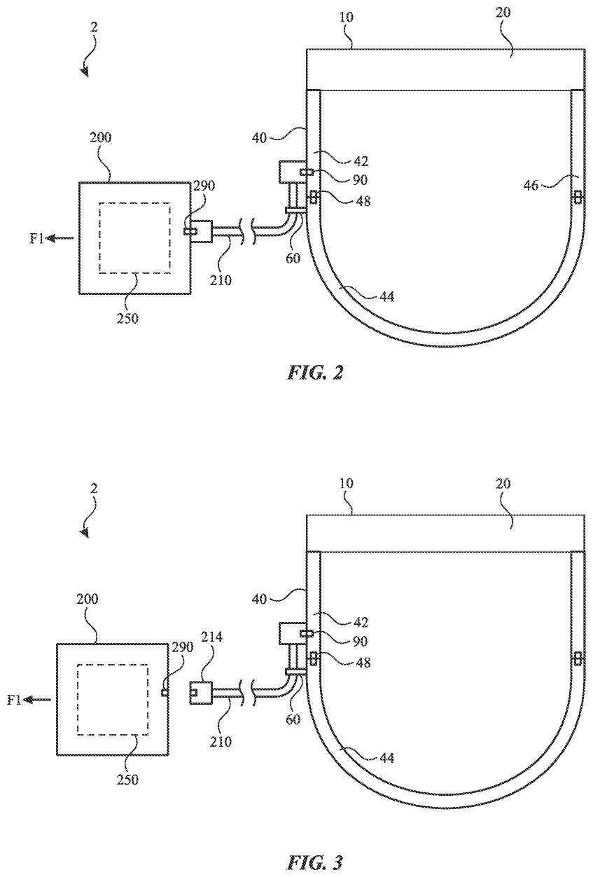

Referring now to FIGS. 2-4, the separate connectors of the system can facilitate maintenance and release of different connections under different conditions. In particular, a variable lock of the head-mountable device 10 can help manage forces applied to the head-mountable device 10. By providing an accessory device 200 that is separate from but connectable to the head-mountable device 10, the head-mountable device 10 may be subject to forces applied to the accessory device 200. For example, if the accessory device 200 is dropped, pulled, or moved a certain distance away from the head-mountable device 10, a corresponding force may be applied to the head-mountable device 10. Depending on the type of force, it may be beneficial to either release the accessory device 200 from the head-mountable device 10 or release the head-mountable device 10 from the user.

As shown in FIG. 2, the head engager 40 can include multiple segments, such as a first segment 42, a second segment 44, and/or a third segment 46. The segments (e.g., of any number) and the frame 20 can together form a continuous loop for encircling a head of the user. The segments can be securely but releasably connected to each other, for example by a segment connector 48. The segment connector can release the segments from each other and thereby release the head-mountable device 10 from the head of the user in response to certain types of forces, as described further herein. One or more of various mechanisms can be provided to secure the segments to each other. For example, the segment connector 48 can include locks, latches, snaps, slides, channels, screws, clasps, threads, magnets, pins, an interference (e.g., friction) fit, knurl presses, bayoneting, fused materials, weaves, knits, braids, and/or combinations thereof to couple and/or secure the segments together. It will be understood that the segment connector 48 can include and/or interact with components on either or both of the segments to be connected thereby.

The tether connector 90 can securely engage the tether 210 to the head-mountable device 10 while facilitating release thereof from the head-mountable device 10 in response to certain types of forces, as described further herein. One or more of various mechanisms can be provided to secure the tether 210 to the head-mountable device 10. For example, the tether connector 90 can include locks, latches, snaps, slides, channels, screws, clasps, threads, magnets, pins, an interference (e.g., friction) fit, knurl presses, bayoneting, fused materials, weaves, knits, braids, and/or combinations thereof to couple and/or secure the segments together. It will be understood that the tether connector 90 can include and/or interact with components on either or both of the head-mountable device 10 and/or the tether 210 to be connected thereby.

The body connector 290 can securely engage the tether 210 to the body 230 of the accessory device 200 while facilitating release thereof from the head-mountable device 10 in response to certain types of forces, as described further herein. One or more of various mechanisms can be provided to secure the tether 210 to the body 230 of the accessory device 200. For example, the body connector 290 can include locks, latches, snaps, slides, channels, screws, clasps, threads, magnets, pins, an interference (e.g., friction) fit, knurl presses, bayoneting, fused materials, weaves, knits, braids, and/or combinations thereof to couple and/or secure the segments together. It will be understood that the body connector 290 can include and/or interact with components on either or both of the body 230 and/or the tether 210 to be connected thereby.

A variable lock 60 of the head-mountable device can distinguish between low-impulse and high-impulse forces applied to one or more connection regions. As shown in FIG. 2, in the event of a low-impulse force, the variable lock can secure segments of a head engager together so the head-mountable device can remain on the head of the user. As used herein, a low-impulse force is a force of a given magnitude that is applied within a relatively short interval of time. For example, a sudden application of a force (e.g., from a drop event and gravitational acceleration of the accessory device 200) can be applied via a rapid increase in tension along the tether 210. By further example, a low-impulse force at a location (e.g., connector) applies relatively high acceleration within a relatively short interval of time at the connector. In response, it can be beneficial to maintain the head-mountable device 10 on the head of the user and optionally facilitate disconnection of the accessory device 200.

For example, the tether connector 90 can engage the tether 210 at one segment (e.g., a first segment 42) of the head engager 40, and the variable lock 60 can engage the tether at a different segment (e.g., a second segment 44) of the head engager 40. The variable lock 60 can manage and/or mitigate forces applied from the accessory device 200. For example, if the accessory device 200 is dropped, pulled, or moved a certain distance away from the head-mountable device 10, a corresponding force may be applied to the head-mountable device 10 via the tether 210.

Where a low-impulse force, F₁, is applied, the variable lock 60 can engage or maintain engagement to a portion of the tether 210 to limit transfer of forces to the first segment 42. For example, the variable lock 60 can distribute forces from the tension in the tether 210 to the first segment 42 via both the tether connector 90 and the segment connector 48. By distributing the incoming low-impulse force, F₁, between two connectors (e.g., the tether connector 90 and the segment connector 48 in parallel), each of the connectors can maintain its connection to the first segment 42 if the portion applied thereto is less than its threshold for release, even if the total incoming low-impulse force, F₁, would have exceeded the threshold of either one, alone, if applied directly thereto. By further example, the tether connector 90 and the variable lock 60 can reinforce the segment connector 48 in its role of maintaining a connection between segments (e.g., the first segment 42 and the second segment 44). As such, the head engager 40 can maintain a continuous loop and remain engaged on the head of the user.

Optionally, the accessory device 200 can also remain connected during application of a low-impulse force, F₁. It will be understood that the same force can be applied at opposite ends of the tether 210, namely at the body 230 of the accessory device 200. Where the body connector 290 has a threshold for release that is not exceeded by the low-impulse force, F₁, the body 230 can remain connected to the tether 210.

As shown in FIG. 3, the accessory device can optionally be disconnected from the head-mountable device. While the variable lock 60 manages the incoming low-impulse force, F₁, the same force can be applied at an opposite end of the tether 210, namely at the body 230 of the accessory device 200. Where the body connector 290 has a threshold for release that is exceeded by the low-impulse force, F₁, the body 230 can disconnect, detach, and/or be released from the tether 210 and/or the accessory device 200 can otherwise disconnect, detach, and/or be released from the head-mountable device 10. This can allow any momentum of the accessory device 200 to be maintained therein rather than be transferred by applying additional forces to the head-mountable device 10. As such, the body connector 290 can have a threshold for release that is lower than the threshold for releasing either the tether connector 90 or the segment connector 48 when the variable lock 60 responds to the low-impulse force, F₁. Put another way, the variable lock 60 responds to the low-impulse force, F₁, by increasing the threshold for releasing the tether connector 90 and/or the segment connector 48. Additionally or alternatively, the variable lock 60 responds to the low-impulse force, F₁, by managing forces so that the low-impulse force, F₁, is distributed across both the tether connector 90 and/or the segment connector 48, while at the opposite end of the tether 210, the same magnitude of low-impulse force, F₁, is applied to only the body connector 290. Accordingly, the tether connector 90 and the segment connector 48 have a combined release threshold (while in parallel as the variable lock 60 engages the tether 210) that is greater than the release threshold of the body connector 290.

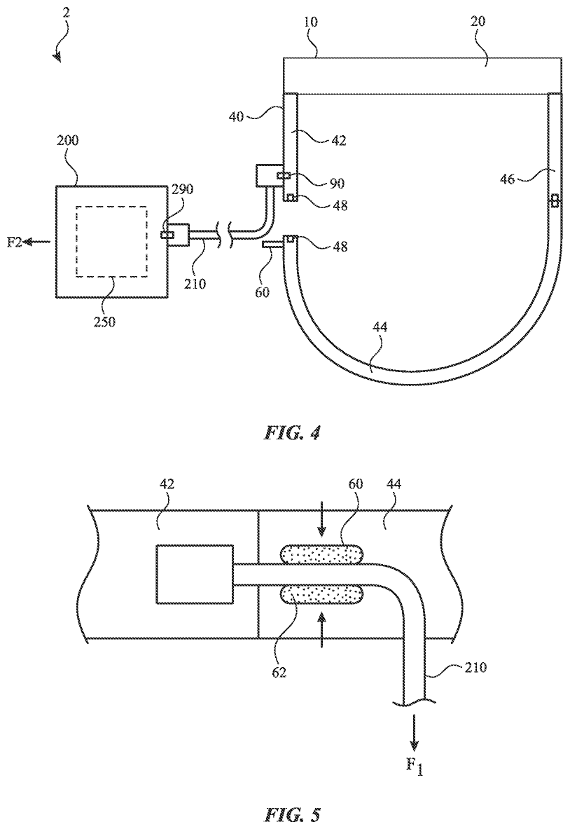

As shown in FIG. 4, in the event of a high-impulse force, the variable lock can separate or facilitate separation of the continuous loop. The continuous loop can be formed, at least in part, by the head engager 40 and/or the frame 20 and help secure the head-mountable device 10 to a head of the user. The separation of the continuous loop can include separation of discrete segments of the head engager 40 from each other and/or separation of the head engager 40 from the frame 20. The effects of the separation can include a release of tension or other forces that hold the head-mountable device 10 on a head of the user. For example, the head engager 40 and/or the frame 20 can be released from the head of the user so that further forces applied to the head-mountable device 10 (e.g., via the tether 210) may not be transmitted to the head of the user, but rather the head-mountable device 10 is allowed to move as desired away from the user.

As used herein, a high-impulse force is a force of a given magnitude that is applied within a relatively long interval of time. For example, a gradual application of a force (e.g., from the accessory device 200 being stuck and/or caught and slowly pulling away relative to the head-mountable device 10) can be applied via a slow increase in tension along the tether 210. By further example, a high-impulse force at a location (e.g., connector) applies relatively low acceleration within a relatively long interval of time at the connector. In response, it can be beneficial to release the head-mountable device 10 from the head of the user.

Where a high-impulse force, F₂, is applied, the variable lock 60 can reduce or release engagement to the portion of the tether 210 to facilitate a transfer of forces to the first segment 42. For example, the variable lock 60 can allow forces from the tension in the tether 210 to be applied to the first segment 42 while primarily via the tether connector 90, with relatively little or no forces being applied directly to the segment connector 48. By focusing the incoming high-impulse force, F₂, on the tether connector 90, the tether connector 90 and the segment connector 48 can be placed in series, such that the first segment 42 and the second segment 44 may be pulled apart. When the incoming high-impulse force, F₂ exceeds the threshold for release of the segment connector 48, the continuous loop can separate with the segments of the head engager 40 separating from each other and allow the head-mountable device 10 to be released from the head of the user. Such an outcome can be provided, for example, where the threshold for release of the segment connector 48, alone, is lower than the threshold for release of the tether connector 90 and/or the body connector 290.

Additionally or alternatively, the variable lock 60 can allow forces from the tension in the tether 210 to be applied to the head engager 40 and/or the frame 20. For example, the tether 210 can connect to the frame 20, and the variable lock 60 can be located on the head engager 40. When the incoming high-impulse force, F₂ exceeds the threshold for release of the head engager 40 from the frame 20, the continuous loop can separate with the head engager 40 separating from the frame 20 and allow the head-mountable device 10 to be released from the head of the user.

Referring now to FIGS. 5-10, a variety of mechanisms can be provided to facilitate impulse-dependent engagement of the variable lock. While various mechanisms are described herein, the variable lock is not limited to any one or more of the examples illustrated herein.

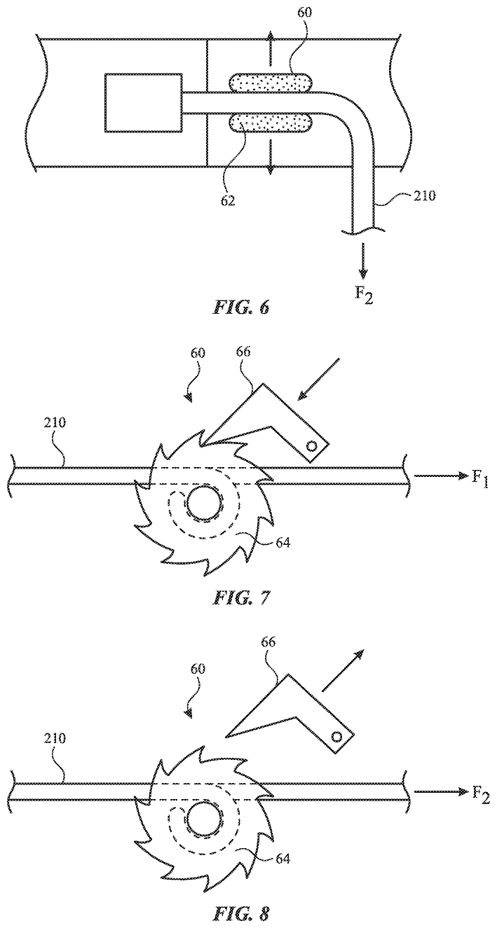

As shown in FIGS. 5-6, the variable lock 60 can include a clip 62 that responds differently to different force impulses. For example, the clip 62 can include a non-Newtonian fluid that has a higher viscosity under certain forces, such as a low-impulse force, F₁, and a lower viscosity under other forces, such as a high-impulse force, F₂. For example, as shown in FIG. 5, the clip 62 can be biased against the tether 210. As the tether 210 moves rapidly under a low-impulse force, F₁, the clip 62 can increase its viscosity and its engagement on the tether 210. In contrast, as shown in FIG. 6, as the tether 210 moves slowly under a high-impulse force, F₂, the clip 62 can decrease its viscosity and its engagement on the tether 210. Accordingly, lower-impulse forces can be transferred, at least in part, to the second segment 44, and higher-impulse forces can be passed through to the first segment 42.

As shown in FIGS. 7-8, the variable lock 60 can include a locking retractor 64 that selectively locks in response to different force impulses. For example, the tether 210 can wrap around a sprocket of the locking retractor 64 to cause it to rotate as the tether 210 feeds in either of two directions. As shown in FIG. 7, in response to a low-impulse force, F₁, a lock bar 66 can engage the sprocket to arrest its rotation, thereby preventing the tether 210 from advancing and transferring forces from the tension in the tether 210 to a corresponding segment to which the locking retractor 64 is mounted. The lock bar 66 can be engaged based on acceleration of the tether 210 and/or its interaction with the variable lock 60. For example, the acceleration of the tether 210 and/or the variable lock 60 can cause the lock bar 66 to tilt towards and to the sprocket. In contrast, as shown in FIG. 8, as the tether 210 moves slowly under a high-impulse force, F₂, the lock bar 66 is not engaged with the locking retractor 64, thereby allowing the tether 210 to move under tension.

It will be understood that other mechanisms can be provided. For example, dampeners can be provided to limit the movement of the tether within a range of velocities. For example, the tether 210 can be coupled to piston movable within a chamber, wherein a fluid within the chamber limits the rate at which the piston can move. As a low-impulse force, F₁, is applied, the fluid limits movement of the piston such that excessive forces within a time interval are transferred to the segment to which the chamber is mounted.

It will be understood that at least some of the mechanisms described herein are passive, in that such mechanisms do not require active (e.g., powered) monitoring and activation. In other embodiments, a variable lock can be at least partially actively controlled.

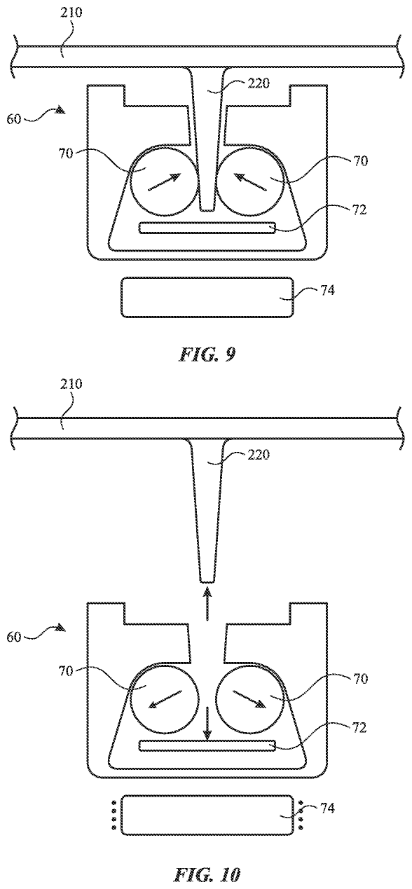

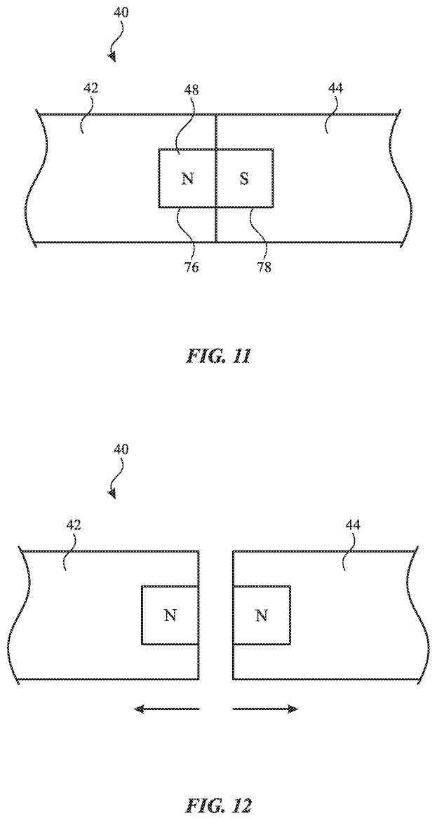

As shown in FIGS. 9 and 10, a variable lock 60 can include one or more beads 70 that apply friction or otherwise grip a pin 220 attached to the tether 210. The beads 70 resist or prevent removal of the pin 220 from the variable lock 60 until disengaged therefrom. For example, a plate 72 can bias the beads inwardly against the pin 220. As shown in FIG. 10, an electromagnet 74 can be operated to move the plate 72 and allow the beads 70 to release the pin 220. For example, the electromagnet 74 can detect movement of the accessory device and/or the tether. When such movement meets certain conditions (e.g., being high impulse rather than low impulse), the electromagnet 74 can be operated to release the tether 210. Such detections can be made by one or more sensors operatively or communicatively connected to the a variable lock 60.

It will be understood that other locking mechanisms can be controllably released upon detection of certain conditions (e.g., high impulse rather than low impulse). Such mechanisms as latches, locks, and the like can then be released by operation of, for example, an actuator. Additionally or alternatively, locking mechanisms can be controllably engaged upon detection of certain conditions (e.g., low impulse rather than high impulse).

While the engagement of the variable lock can be controlled in some embodiments, other mechanisms can be employed. For example, the engagement of the segment connector 48 itself can be modified based on detected conditions. As shown in FIG. 11, the segment connector 48 can include one or more magnetic assemblies 76 and 78, which can include permanent magnets (e.g., “hard” magnets), electromagnets, and/or magnetizable materials (e.g., “soft” magnets). The magnetic assemblies 76 and 78 can provide engagement with a first threshold for release. Upon detection of movement of the accessory device and/or a tether, the further detections can include a characteristic of such movement (e.g., low impulse or high impulse). In response to a low-impulse force, an electromagnet (e.g., one or more of the magnetic assemblies 76 and 78) can be operated to maintain engagement of the segment connector 48 and hold the segments 42 and 44 together. In response to a high-impulse force, an electromagnet (e.g., one or more of the magnetic assemblies 76 and 78) can be operated to release the segment connector 48 and allow the segments 42 and 44 to separate. It will be understood that engagement or separation can be a passive steady state of the segment connector 48 (e.g., with at least one permanent magnet), such that an electromagnet need only be operated to change from the steady state to another state.

It will be understood that other locking mechanisms of a segment connector 48 can be controllably engaged and/or released upon detection of certain conditions (e.g., low impulse rather than high impulse). Such mechanisms as latches, locks, and the like can be released by operation of, for example, an actuator. Additionally or alternatively, locking mechanisms can be controllably engaged upon detection of certain conditions (e.g., high impulse rather than low impulse).

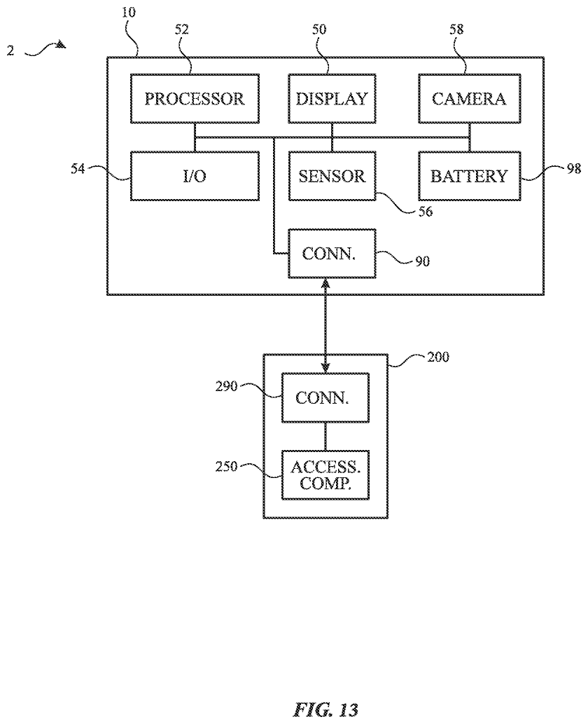

FIG. 13 illustrates a block diagram of a system including a head-mountable device and one or more accessory devices, in accordance with some embodiments of the present disclosure. It will be appreciated that components described herein can be provided on either or both of a head-mountable device and/or an accessory device. In some embodiments, components are provided by an accessory device and/or an external device instead of a head-mountable device to reduce redundancy and increase customization based on a selection of accessory devices.

It will be understood that any one or more of the components of the head-mountable device 10 described herein can correspond to an HMD component of FIGS. 1-12. As such, the accessory circuitry 250 of the accessory device 200 can interact with any one or more of the components of the head-mountable device 10 illustrated in FIG. 13.

As shown in FIG. 13, the head-mountable device 10 can include a processor 52 with one or more processing units that include or are configured to access a memory having instructions stored thereon. The instructions or computer programs may be configured to perform one or more of the operations or functions described with respect to the head-mountable device 10. The processor 52 can be implemented as any electronic device capable of processing, receiving, or transmitting data or instructions. For example, the processor 52 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements. The memory can store electronic data that can be used by the head-mountable device 10. For example, the memory can store electrical data or content such as, for example, audio and video files, documents and applications, device settings and user preferences, timing and control signals or data for the various modules, data structures or databases, and so on. The memory can be configured as any type of memory. By way of example only, the memory can be implemented as random access memory, read-only memory, Flash memory, removable memory, or other types of storage elements, or combinations of such devices.

The head-mountable device 10 can include a camera 58 for capturing a view of an environment external to the head-mountable device 10. The camera 58 can include an optical sensor, such as a photodiode or a photodiode array. Additionally or alternatively, the camera 58 can include one or more of various types of optical sensors that are arranged in various configurations for detecting user inputs described herein. The camera 58 may be configured to capture an image of a scene or subject located within a field-of-view of the camera 58. The image may be stored in a digital file in accordance with any one of a number of digital formats. In some embodiments, the head-mountable device 10 includes a camera, which includes an image sensor formed from a charge-coupled device (CCD) and/or a complementary metal-oxide-semiconductor (CMOS) device, a photovoltaic cell, a photo resistive component, a laser scanner, and the like. It will be recognized that a camera can include other motion sensing devices.

The head-mountable device 10 can further include a display 50 for displaying visual information for a user. The display 50 can provide visual (e.g., image or video) output. The display 50 can be or include an opaque, transparent, and/or translucent display. A transparent or translucent display 50 may have a medium through which light representative of images is directed to a user's eyes. The display 50 may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The head-mountable device 10 can include an input/output component 54, which can include any suitable component for connecting head-mountable device 10 to other devices. Suitable components can include, for example, audio/video jacks, data connectors, or any additional or alternative input/output components. The input/output component can include buttons, keys, or another feature that can act as a keyboard for operation by the user. As such, the description herein relating to keyboards can apply to keyboards, keys, and/or other input features integrated on the head-mountable device 10. Such an input/output component can be fixedly or removably attached to a display unit of the head-mountable device 10.

The head-mountable device 10 can include communications interface with a tether connector 90 for communicating with one or more servers or other devices using any suitable communications protocol. For example, communications interface can support Wi-Fi (e.g., a 802.11 protocol), Ethernet, Bluetooth, high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. A communications interface can also include an antenna for transmitting and receiving electromagnetic signals.

The head-mountable device 10 can include the HMD communication interface of a tether connector 90 for communicating with the accessory device 200 via the body connector 290. The head-mountable device 10 can provide one or more tether connectors 90 for communicating with a corresponding number of accessory devices 200. Additionally or alternatively, a number of accessory devices 200 can communicate with the head-mountable device 10 via a smaller or greater number of tether connectors 90.

The head-mountable device 10 can one or more sensors 56 may also include various sensors that detect conditions pertaining to the user, the head-mountable device 10, and/or the head engager. For example, in addition to the camera 58, the head-mountable device 10 may include motion sensors, such as one or more of accelerometers, gyroscopes, magnetometers, inertial measurement units (IMU), cameras, or the like, which measure conditions pertaining to the position and/or orientation of the head of the user and/or the head-mountable device 10.

The sensor 56 can include one or more eye sensors for tracking features of the user wearing the head-mountable device 10, including conditions of the user's eye (e.g., focal distance, pupil size, etc.). For example, such sensors can perform facial feature detection, facial movement detection, facial recognition, eye tracking, user mood detection, user emotion detection, voice detection, etc. For example, an eye sensor can optically capture a view of an eye (e.g., pupil) and determine a direction of a gaze of the user.

The head-mountable device 10 can include one or more other sensors. Such sensors can be configured to sense substantially any type of characteristic such as, but not limited to, images, pressure, light, touch, force, temperature, position, motion, and so on. For example, the sensor can be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. By further example, the sensor can be a bio-sensor for tracking biometric characteristics, such as health and activity metrics. Other user sensors can perform facial feature detection, facial movement detection, facial recognition, eye tracking, user mood detection, user emotion detection, voice detection, etc.

The head-mountable device 10 can include a battery 98, which can charge and/or power components of the head-mountable device 10. The battery 98 can also charge and/or power components connected to the head-mountable device 10.

Each accessory device 200 can be controlled at least in part by the processor 52 of the head-mountable device 10. For example, while the accessory device 200 is connected to the head-mountable device 10, the processor 52 of the head-mountable device 10 can operably connect to and/or control one or more components of the accessory device 200 via the communication link provided by the HMD communication interface 80 and the accessory communication interface 180.

Additionally or alternatively, the head-mountable device 10 can be controlled at least in part by the accessory circuitry 250 of the accessory device 200. For example, while the accessory device 200 is connected to the head-mountable device 10, the accessory circuitry 250 of an accessory device 200 can operably connect to and/or control one or more components of the head-mountable device 10 via the communication link provided by the HMD communication interface 80 and the accessory communication interface 180.

In some embodiments, the accessory device 200 can operate as a power source for the head-mountable device 10. By providing power with a removable accessory device, the user can select such an accessory device according to anticipated power needs. The accessory circuitry 250 can include a battery that is used to store and provide power to the head-mountable device 10 and/or the accessory device 200. Optionally, the accessory device 200 can recharge the battery 98 of the head-mountable device 10, for example, by directing power from the accessory circuitry 250 (e.g., battery) across the tether connector 90. Other pathways are contemplated, such as another link or wireless charging. The battery can be a replaceable battery, a rechargeable battery. Additionally or alternatively, the accessory circuitry 250 can be a tethered power source that receives power from a source external to the accessory device 200, such as from a USB cable, Lightening cable, or other interface. One or more batteries of the head-mountable device can transfer power to and/or receive power from another device. Such power transfer can be wired and/or wireless.

Further examples of accessory circuitry 250 include speakers. Such speakers can be operated in concert with or independently of the speakers of the head-mountable device 10. Speakers of the accessory device 200 can be provided and operated at locations that enhance the audio output of the combined system 2. For example, the speakers of the accessory device 200 can be operated to provide spatial audio to the user.

Further examples of accessory circuitry 250 include cameras. Such cameras can be operated in concert with or independently of the cameras 130 of the head-mountable device 10. Cameras of the accessory device 200 can be provided and operated at locations that enhance the visual capture capabilities of the combined system 2. For example, the cameras of the accessory device 200 (optionally with the cameras 58 of the head-mountable device 10) can be operated in concert to capture a combined image that spans a wide field of view. For example, the field of view can be greater than 90°, 180°, 270°, or up to 360°. Images captured by one or more of the cameras of the accessory device 200 can be displayed on the display 50 of the head-mountable device 10.

Further examples of accessory circuitry 250 include microphones. Such microphones can be operated in concert with or independently of microphones of the head-mountable device 10. Microphones of the accessory device 200 can be provided and operated at locations that enhance the audio capture capabilities of the combined system 2. For example, the microphones of the accessory device 200 can be operated to capture directional audio from an environment of the user.

Further examples of accessory circuitry 250 include sensors. By providing sensing capabilities with a removable module, the user can select such an accessory device 200 when sensing particular conditions is desired. Such sensors can be configured to sense substantially any type of characteristic such as, but not limited to, images, pressure, light, touch, force, temperature, position, motion, and so on. For example, the sensor may be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. The sensor can be used to sense ambient conditions in a neighboring environment. The sensor can be provided with exposure to the environment, for example with an opening in the accessory device 200.

Further examples of accessory circuitry 250 include bio-sensors. By providing bio-sensing capabilities with a removable module, the user can select such an accessory device 200 when tracking biometric characteristics, such as health and activity metrics, is desired. The one or more bio-sensors can include optical and/or electronic biometric sensors that may be used to compute one or more biometric characteristics. For example, a bio-sensor can include a light source and a photodetector to form a photoplethysmography (PPG) sensor. An optical (e.g., PPG) sensor or sensors may be used to compute various biometric characteristic including, without limitation, a heart rate, a respiration rate, blood oxygenation level, a blood volume estimate, blood pressure, or a combination thereof. One or more of the bio-sensors may also be configured to perform an electrical measurement using one or more electrodes. The electrical sensor(s) may be used to measure electrocardiographic (ECG) characteristics, galvanic skin resistance, and other electrical properties of the user's body. Additionally or alternatively, a bio-sensor can be configured to measure body temperature, exposure to UV radiation, and other health-related information.

Further examples of accessory circuitry 250 include user sensors. Such sensors can be used to detect features relating to the user wearing the head-mountable device and/or other individuals. For example, user sensors can perform facial feature detection, facial movement detection, facial recognition, eye tracking, user mood detection, user emotion detection, voice detection, etc.

Further examples of accessory circuitry 250 include components for receiving input from a user, providing output to a user, and/or performing other functions. Examples of such components include a speaker, a microphone, a display, a touch sensor, a haptic device, a camera, an optical sensor, a magnet, a gyroscope, an accelerometer, and/or another I/O component. The I/O components can be used to detect and interpret user inputs. The I/O components can be used to provide information to the user. The I/O components can also be used to capture information relating to the user and/or the environment.

Examples of accessory circuitry 250 include display drivers. By providing display drivers with a removable module, the user can select such an accessory device 200 when certain display features are desired. Such display drivers can be configured to control the display 50 of the head-mountable device 10.

Each accessory device 200 can further include any number of accessory circuitries 250. By providing accessory circuitry on a removable accessory device, the user can optionally provide an appropriate accessory device when selected functions are desired. At other times, other accessory devices or no accessory device can be selected, thereby reducing the need to have all features available at all times in the head-mountable device 10.

The head-mountable device 10 can provide an output to a user based on an action relating to the accessory device 200. For example, the head-mountable device 10 can provide an output upon attachment and/or removal of the accessory device 200 with respect to the head-mountable device 10. By further example, the head-mountable device 10 can provide an output upon detection of a user input provided at the accessory device 200. The output provided by the head-mountable device 10 can include a confirmation relating to an operation and/or condition (e.g., installed, absent, active, inactive, charged, etc.) of the accessory device 200. The output provided by the head-mountable device 10 can include a prompt relating to an action for the user to perform. The output can be provided according to the operation of the processor 52 of the head-mountable device 10 and produce by one or more components of the head-mountable device 10 that is operably connected to the processor 52. For example, the output can be a visual output produced by the display 50, an audio output produced by the speaker, a haptic output produced by a haptic device, or another output that is detectable by the user and produced by another component of the head-mountable device.

Additionally or alternatively, the head-mountable device 10 can alter one or more parameters of its operations based on the presence, absence, or other condition of the accessory device 200. For example, when the accessory device 200 is installed, the head-mountable device 10 may perform an action the utilized the functions of the accessory device 200. By further example, when the accessory device 200 is absent, the head-mountable device 10 may perform an action that does not rely on the functions of the accessory device 200. Additionally or alternatively, the head-mountable device 10 may perform actions in a manner that consumes power based on the presence, absence, and/or amount of power provided by an accessory device 200. For example, the head-mountable device 10 can perform an action with greater power consumption (e.g., high-resolution display output, enhanced audio and/or imaging processing, communication with accessory devices) when a battery of the accessory device 200 is present and sufficiently charged, and the head-mountable device 10 can perform an action with lower power consumption (e.g., low-resolution display output, reduced audio and/or imaging processing, reduced communication with accessory devices) or refrain from performing such an action when a battery of the accessory device 200 is absent or not sufficiently charged.

The accessory device 200 can be configured to interact with at least one other device other than the head-mountable device 10. For example, the accessory device 200 can be charged by an external device with a power source, so that the battery of the accessory device 200 carries a charge for transfer to the head-mountable device 10. Communication between an external device and the accessory device 200 can optionally be conducted via the connector(s) of the accessory device 200. Such an external device can further be configured to interact independently with the head-mountable device 10, for example to charge the battery 98 of the head-mountable device 10. Communication between an external device and the head-mountable device 10 can optionally be conducted via the tether connector 90 of the head-mountable device 10.

It will be understood that the components of either the head-mountable devices and/or accessory devices discussed herein can be provided on one or more of the head-mountable devices and/or accessory devices. Furthermore, selection of different accessory devices provides a customized experience for a user.

It will be recognized that the difference in functionality between accessory devices can refer to both the purpose of a component as well as the parameters of its operation. For example, while the components of different accessory devices can both be for a common purpose, the components can operate differently to achieve the purpose. For example, different components can be for sensing different conditions based on the operations desired by a user. Other variations, such as size, shape, and material selection can be provided so the user can select the accessory device that is best suited for the user's comfort and/or performance of the component.

The different accessory devices can also differ in mechanical configuration such as material properties and/or structural features, which can help define shape, size, flexibility, rigidity, tactile feel, and/or aesthetic properties such as color, patterns, and/or materials to provide a different look and feel. Furthermore, each of the accessory devices may have a different enclosure having a different color, material, shape, accoutrements, patterns, etc. The enclosures can provide different aesthetic features, cosmetic features, and/or a look and feel than the other enclosures in the system.

While the components of different accessory devices can differ, the accessory devices can have the same or similar connectors, including communication interfaces, so that each of the multiple accessory devices can attach to and communicate with the same head-mountable device in the same or similar manner.

Accordingly, each accessory device is configured to provide a different function and/or aesthetic feature than one or more other accessory devices in the system. As such, the user can select the accessory device with the desired functionality and/or look and feel. This may be at the time of purchase, thus allowing differentiation from other purchasers, or it may be that all or some portion of the accessory devices come in a set such that the user can select the desired accessory devices for the right moment. In one example, one accessory device may be configured for use outside the home, while another may be configured for use at home. Any combination of aesthetic and functional features may be provided to create a different head-mountable device. When combined with the different head-mountable devices, the system becomes highly customizable. The user can create a different head-mountable device by selecting one head-mountable device to go along with one set of accessory devices. If multiple systems are provided, any number of different head-mountable device configurations can be made.

Accordingly, embodiments of the present disclosure provide a head-mountable device that facilitates operation thereof with an accessory device. Such connections there between can provide both mechanical engagement and operable communication between the connected devices. A variable lock of the head-mountable device can distinguish between low-impulse and high-impulse forces applied to one or more connection regions. In the event of a low-impulse force, the variable lock can secure segments of a head engager together so the head-mountable device can remain on the head of the user. Optionally, the accessory device can be disconnected from the head-mountable device. In the event of a high-impulse force, the variable lock can allow segments of the head engager to separate so the head-mountable device can be released from the head of the user.

Various examples of aspects of the disclosure are described below as clauses for convenience. These are provided as examples, and do not limit the subject technology.

Clause A: a system comprising: a head-mountable device comprising: a frame; a display supported by the frame; and a head engager comprising: a first segment comprising a tether connector; and a second segment comprising a variable lock; and an accessory device comprising: a body containing an accessory circuitry; a tether, wherein the tether connector of the first segment and the variable lock of the second segment are configured to engage the tether; and a body connector coupling the tether to the body, wherein the variable lock of the second segment is configured to transmit a force applied to the tether to either the first segment or the second segment based on a level of an impulse associated with the force.

Clause B: a head-mountable device comprising: a frame; a head engager connected to the frame to form a continuous loop, the head engager being configured to connect to a tether connected to an accessory device, wherein the head engager is configured to: in response to a first force applied to the tether with a first impulse, maintain the continuous loop; and in response to a second force applied to the tether with a second impulse greater than the first impulse, separate the continuous loop.

Clause C: a head-mountable device comprising: a frame; a head engager comprising a first segment and a second segment, wherein the frame, the first segment, and the second segment form a continuous loop; a tether connector configured to engage a tether connected to an accessory device at the first segment; and a variable lock configured to engage the tether at the second segment, wherein the variable lock is configured to: receive an indicator of a condition associated with the accessory device; based on the condition, determine an action comprising engaging the tether or releasing the tether; and perform the action.

One or more of the above clauses can include one or more of the features described below. It is noted that any of the following clauses may be combined in any combination with each other, and placed into a respective independent clause, e.g., Clause A, B, or C.

Clause 1: in response to a first force applied to the tether with a first impulse, the variable lock is configured to prevent the first segment and the second segment from separating such that the accessory device detaches from the head-mountable device; and in response to a second force applied to the tether with a second impulse greater than the first impulse, allow the first segment and the second segment to separate from each other.

Clause 2: the head-mountable device further comprises a first battery, the accessory circuitry comprises a second battery; and the first battery is operably connected to the second battery when the tether is connected to the body connector and the tether connector.

Clause 3: the head-mountable device further comprises: a camera; an eye sensor; a microphone; and a speaker.

Clause 4: the accessory circuitry comprises a sensor, wherein the variable lock is operable based on a condition detected by the sensor.

Clause 5: each of the tether connector and the body connector comprises an engager and a communication interface.

Clause 6: the first segment and the second segment are configured to releasably engage each other with a segment connector.

Clause 7: a release threshold of the body connector is higher than a release threshold of the tether connector or a release threshold of the segment connector.

Clause 8: when the variable lock engages the tether, the tether connector and the segment connector have a combined release threshold that is greater than the release threshold of the body connector.

Clause 9: the segment connector comprises a first magnetic assembly on the first segment and a second magnetic assembly on the second segment, wherein at least one of the first magnetic assembly and the second magnetic assembly comprises an electromagnet.

Clause 10: the accessory device is a wearable device.

Clause 11: the variable lock comprises a clip with a non-Newtonian fluid configured to selectively engage the tether.

Clause 12: the variable lock comprises a locking retractor rotatable by the tether and a lock bar configured to selectively engage the locking retractor.

Clause 13: the multiple segments comprise a first segment and a second segment that are releasably engaged to each other with a segment connector, the multiple segments and the frame forming the continuous loop while the segment connector is engaged.

Clause 14: the condition is an acceleration of the accessory device, and the indicator is transmitted from the accessory device to the head-mountable device.

Clause 15: the variable lock comprises beads configured to engage a pin connected to the tether and an electromagnet configured to selectively release the beads from the pin.

Clause 16: the first segment and the second segment are configured to releasably engage each other with a segment connector.

Clause 17: the segment connector comprises a first magnetic assembly on the first segment and a second magnetic assembly on the second segment, wherein at least one of the first magnetic assembly and the second magnetic assembly comprises an electromagnet.

Clause 18: the head engager comprises: multiple segments connectable to each other by a head engager connector, at least one of the multiple segments being configured to connect to the tether of the accessory device; and a variable lock; in response to the first force, the variable lock is configured to prevent the multiple segments of the head engager from separating; and in response to the second force, the variable lock is configured to allow the multiple segments of the head engager to separate from each other.

Clause 19: in response to the first force applied to the tether with the first impulse, the variable lock is configured to secure the head engager such that the accessory device is released from the head engager.

A physical environment relates to a physical world that people can sense and/or interact with without necessarily requiring the aid of an electronic device. A computer-generated reality environment relates to a wholly or partially simulated environment that people sense and/or interact with the assistance of an electronic device. Examples of computer-generated reality include mixed reality and virtual reality. Examples of mixed realities can include augmented reality and augmented virtuality. Some examples of electronic devices that enable a person to sense and/or interact with various computer-generated reality environments include head-mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable device can have an integrated opaque display, have a transparent or translucent display, or be configured to accept an external opaque display (e.g., smartphone).

As described above, one aspect of the present technology may include the gathering and use of data. The present disclosure contemplates that in some instances, this gathered data may include personal information or other data that uniquely identifies or can be used to locate or contact a specific person. The present disclosure contemplates that the entities responsible for the collection, disclosure, analysis, storage, transfer, or other use of such personal information or other data will comply with well-established privacy policies and/or privacy practices. The present disclosure also contemplates embodiments in which users can selectively block the use of or access to personal information or other data (e.g., managed to minimize risks of unintentional or unauthorized access or use).

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A head-mountable device comprising:
a frame; and
a head engager connected to the frame to form a continuous loop, the head engager being configured to connect to a tether connected to an accessory device, wherein the head engager is configured to:
in response to a first force applied to the tether with a first impulse, maintain the continuous loop; and
in response to a second force applied to the tether with a second impulse greater than the first impulse, separate the continuous loop.

2. The head-mountable device of claim 1, wherein:
the head engager comprises:
multiple segments connectable to each other by a head engager connector, at least one of the multiple segments being configured to connect to the tether; and
a variable lock;
in response to the first force, the variable lock is configured to prevent the multiple segments of the head engager from separating; and
in response to the second force, the variable lock is configured to allow the multiple segments of the head engager to separate from each other.

3. The head-mountable device of claim 2, wherein, in response to the first force applied to the tether with the first impulse, the variable lock is configured to secure the head engager such that the accessory device is released from the head engager.

4. The head-mountable device of claim 2, wherein the variable lock comprises a clip with a non-Newtonian fluid configured to selectively engage the tether.

5. The head-mountable device of claim 2, wherein the variable lock comprises a locking retractor rotatable by the tether and a lock bar configured to selectively engage the locking retractor.

6. The head-mountable device of claim 2, wherein the multiple segments comprise a first segment and a second segment that are releasably engaged to each other with a segment connector, the multiple segments and the frame forming the continuous loop while the segment connector is engaged.

7. A system comprising:
a head-mountable device comprising:
a frame;
a display supported by the frame; and
a head engager comprising:
a first segment comprising a tether connector; and
a second segment comprising a variable lock; and
an accessory device comprising:
a body containing accessory circuitry;
a tether, wherein the tether connector of the first segment and the variable lock of the second segment are configured to engage the tether; and
a body connector coupling the tether to the body, wherein the variable lock of the second segment is configured to transmit a force applied to the tether to either the first segment or the second segment based on an impulse associated with the force.

8. The system of claim 7, wherein:
in response to a first force applied to the tether with a first impulse, the variable lock is configured to prevent the first segment and the second segment from separating such that the accessory device detaches from the head-mountable device; and
in response to a second force applied to the tether with a second impulse greater than the first impulse, allow the first segment and the second segment to separate from each other.

9. The system of claim 7, wherein:
the head-mountable device further comprises a first battery;
the accessory circuitry comprises a second battery; and
the first battery is operably connected to the second battery when the tether is connected to the body connector and the tether connector.

10. The system of claim 7, wherein the accessory circuitry comprises a sensor, wherein the variable lock is operable based on a condition detected by the sensor.

11. The system of claim 7, wherein the first segment and the second segment are configured to releasably engage each other with a segment connector.

12. The system of claim 11, wherein a release threshold of the body connector is higher than a release threshold of the tether connector or a release threshold of the segment connector.

13. The system of claim 12, wherein, when the variable lock engages the tether, the tether connector and the segment connector have a combined release threshold that is greater than the release threshold of the body connector.

14. The system of claim 11, wherein the segment connector comprises a first magnetic assembly on the first segment and a second magnetic assembly on the second segment, wherein at least one of the first magnetic assembly and the second magnetic assembly comprises an electromagnet.

15. The system of claim 7, wherein the accessory device is a wearable device.

16. A head-mountable device comprising:
a frame;
a head engager comprising a first segment and a second segment, wherein the frame, the first segment, and the second segment form a continuous loop;
a tether connector configured to engage a tether connected to an accessory device at the first segment; and
a variable lock configured to engage the tether at the second segment, wherein the variable lock is configured to:
receive an indicator of a condition associated with the accessory device;
based on the condition, determine an action comprising engaging the tether or releasing the tether; and
perform the action.

17. The head-mountable device of claim 16, wherein the condition is an acceleration of the accessory device, and the indicator is transmitted from the accessory device to the head-mountable device.

18. The head-mountable device of claim 16, wherein the variable lock comprises beads configured to engage a pin connected to the tether and an electromagnet configured to selectively release the beads from the pin.

19. The head-mountable device of claim 16, wherein the first segment and the second segment are configured to releasably engage each other with a segment connector.

20. The head-mountable device of claim 19, wherein the segment connector comprises a first magnetic assembly on the first segment and a second magnetic assembly on the second segment, wherein at least one of the first magnetic assembly and the second magnetic assembly comprises an electromagnet.
